(19) United States
(12) Patent Application Publication
(10) Pub. No.: US 2022/0184566 A1
(43) Pub. Date: Jun. 16, 2022

(54) PRODUCTION APPARATUS FOR A LIQUID CONTAINING GAS BUBBLES AND PRODUCTION SYSTEM FOR A LIQUID CONTAINING GAS BUBBLES

(71) Applicant: KYB CORPORATION, Tokyo (JP)

(72) Inventors: Akihisa OOTA, Tokyo (JP); Terumi MORI, Tokyo (JP); Futoshi YOSHIDA, Tokyo (JP); Ryunosuke ISHIKAWA, Tokyo (JP)

(21) Appl. No.: 17/593,993

(22) PCT Filed: Mar. 23, 2020
(86) PCT No.: PCT/JP2020/012723

§ 371 Date: Sep. 29, 2021

(30) Foreign Application Priority Data
Apr. 2, 2019 (JP) 2019-070699

(51) Int. Cl. B01F 23/231; B01F 25/64; B01F 27/74

(52) U.S. Cl. CPC B01F 23/231; B01F 27/74; B01F 25/64

(57) ABSTRACT

[Abstract] A production apparatus for a liquid containing gas bubbles according to an embodiment of the present invention includes a casing and a shearing mechanism unit. The casing includes an inlet, into which a liquid with a gas injected therein flows, and an outlet. The shearing mechanism unit is provided between the inlet and the outlet and applies shearing force to a liquid flowing to the outlet from the inlet. The shearing mechanism unit includes a rotor, a rotation applying unit, and a facing member. The rotor includes a rotary shaft and a tube portion having an outer peripheral portion including a first structure surface in which a plurality of recess portions is formed, and is rotatably disposed inside the casing. The rotation applying unit is provided in the rotary shaft and applies rotating force around the rotary shaft to the rotor. The facing member has an inner peripheral portion that faces the first structure surface via a predetermined clearance and is provided in an inner wall portion of the casing.

### TECHNICAL FIELD

The present invention relates to a production apparatus for a liquid containing gas bubbles and a production system for a liquid containing gas bubbles that generate gas bubbles such as ultra-fine bubbles in a liquid.

### BACKGROUND ART

In recent years, liquids containing gas bubbles, which are obtained by making liquids such as water contain fine gas bubbles, have been prevailed. The fine gas bubbles include ultra-fine bubbles (UFB) having a diameter of 1 μm or less, micro bubbles having a diameter of 10 μm or less, milli-bubbles having a diameter of 1 mm or less, and the like. In particular, UFB water containing UFB has been expected to be used in fields of freshness maintenance of fish and shellfish, microbial culture, sterilized medical care, various types of washing, and the like.

Currently used UFB production apparatuses inject a gas into a liquid, boost the pressure through a liquid feed pump to excessively dissolve the gas, and release the pressure, to thereby generate a large amount of gas bubbles. In addition, the UFB production apparatuses cause a gas-liquid mixed phase fluid to pass through a shear mixer to thereby refine the gas bubbles. For example, Patent Literature 1 has disclosed a static fluid mixer that changes a fluid to be treated into a gas-liquid mixture fluid in which the air and water are mixed and supplies the fluid into a fluid mixing unit.

### CITATION LIST

### Patent Literature

Patent Literature 1: Japanese Patent Application Laid-open No. 2010-149120

### DISCLOSURE OF INVENTION

### Technical Problem

However, a UFB production apparatus as described above requires injecting a gas into a high-pressure liquid, and it has been especially not easy to inject a large amount of gas and generate a liquid containing gas bubbles that contains a large amount of gas bubbles.

In view of the above-mentioned circumstances, it is an object of the present invention to provide a production apparatus for a liquid containing gas bubbles and a production system for a liquid containing gas bubbles that are capable of generating a liquid containing gas bubbles that contains a large amount of gas bubbles.

### Solution to Problem

A production apparatus for a liquid containing gas bubbles according to an embodiment of the present invention includes a casing and a shearing mechanism unit.

The casing includes an inlet, into which a liquid with a gas injected therein flows, and an outlet.

The shearing mechanism unit is provided between the inlet and the outlet and applies shearing force to a liquid flowing to the outlet from the inlet.

The shearing mechanism unit includes a rotor, a rotation applying unit, and a facing member.

The rotor includes a rotary shaft and a tube portion and is rotatably disposed inside the casing, the tube portion having an outer peripheral portion including a first structure surface in which a plurality of recess portions is formed.

The rotation applying unit is provided in the rotary shaft and applies rotating force around the rotary shaft to the rotor.

The facing member has an inner peripheral portion and is provided in an inner wall portion of the casing, the inner peripheral portion facing the first structure surface via a predetermined clearance.

The production apparatus for a liquid containing gas bubbles is configured to rotate the rotor and applies the shearing force to the liquid between the first structure surface and the facing member. Accordingly, bubbles of the gas included in the liquid can be refined, and a liquid containing gas bubbles that contains the refined gas bubbles can be generated.

The inner peripheral portion of the facing member may have a second structure surface which faces the first structure surface and in which a plurality of recess portions is formed.

Accordingly, strong rotational flow can be generated by applying large shearing work to the liquid. Accordingly, refinement of gas bubbles can be promoted, and a liquid containing gas bubbles that contains a large amount of gas bubbles can be efficiently generated.

At least one of the first structure surface or the second structure surface may include a plurality of circular or polygonal recess portions as the plurality of recess portions.

The predetermined clearance may be 1.0 mm or more and 3.0 mm or less.

A production system for a liquid containing gas bubbles according to an embodiment of the present invention includes a tank that reserves a liquid and a production apparatus for a liquid containing gas bubbles.

The production apparatus for a liquid containing gas bubbles includes a casing including an inlet and an outlet, a shearing mechanism unit that is provided between the inlet and the outlet and applies shearing force to a liquid flowing to the outlet from the inlet, a gas injection unit that is connected to the inlet and injects a gas into a liquid introduced into the inlet, and a pump unit that is attached to the shearing mechanism unit and transports a liquid to the outlet from the inlet by driving of a motor. The production apparatus for a liquid containing gas bubbles is placed inside the tank.

The shearing mechanism unit includes a rotor, a motor, a tubular facing member.

The rotor includes a rotary shaft and a tube portion and is rotatably disposed inside the casing, the tube portion having an outer peripheral portion including a first structure surface in which a plurality of recess portions is formed.

The motor is provided in the rotary shaft and applies rotating force around the rotary shaft to the rotor and the pump unit.

The tubular facing member has an inner peripheral portion and is provided in an inner wall portion of the casing, the inner peripheral portion facing the first structure surface via a predetermined clearance.

### BRIEF DESCRIPTION OF DRAWINGS

FIG. 1 A schematic vertical cross-sectional view showing a configuration of a production apparatus for a liquid containing gas bubbles according to this embodiment.

FIG. 2 A cross-sectional view taken in the line direction [A]-[A].

FIG. 3 A perspective view showing a rotor and a facing member in the production apparatus for a liquid containing gas bubbles.

FIG. 4 A schematic view showing a state of a liquid containing gas bubbles flowing between a first structure surface and a second structure surface in the production apparatus for a liquid containing gas bubbles.

FIG. 5 A simulation result showing a relationship between the size of a clearance between the first structure surface and the second structure surface and turbulent flow energy (κ) and turbulent-flow dissipation rate (ε).

FIG. 6 A vertical cross-sectional view showing a configuration of a production apparatus according to Comparison Example 1.

FIG. 7 A schematic perspective view of a rotating plate of the production apparatus according to Comparison Example 1.

FIG. 8 A schematic view describing actions of the production apparatus according to Comparison Example 1.

FIG. 9 Simulation results of assessment of characteristic values of other configuration examples of the production apparatus for a liquid containing gas bubbles.

FIG. 10 A diagram showing a modified example of a configuration of a pump unit in the production apparatus for a liquid containing gas bubbles, in which A is a perspective view and B is a front view.

FIG. 11 A schematic cross-sectional view of a production apparatus for a liquid containing gas bubbles according to a second embodiment of the present invention.

FIG. 12 A cross-sectional view taken in the line direction [B]-[B] in FIG. 11.

FIG. 13 A schematic view showing a configuration of a production system for a liquid containing gas bubbles according to a third embodiment of the present invention.

FIG. 14 A schematic cross-sectional view the production apparatus for a liquid containing gas bubbles according to the third embodiment of the present invention.

FIG. 15 A schematic view showing a configuration of a tank unit serving as a production system for a liquid containing gas bubbles including the production apparatus for a liquid containing gas bubbles according to the first embodiment.

FIG. 16 A schematic configuration diagram of a system including the tank unit.

FIG. 17 A perspective view showing a modified example of a configuration of an impeller in the production apparatus for a liquid containing gas bubbles according to the second embodiment of the present invention.

### MODE(S) FOR CARRYING OUT THE INVENTION

Hereinafter, embodiments of the present invention will be described with reference to the drawings.

### First Embodiment

[Configuration of Production Apparatus for Liquid Containing Gas Bubbles]

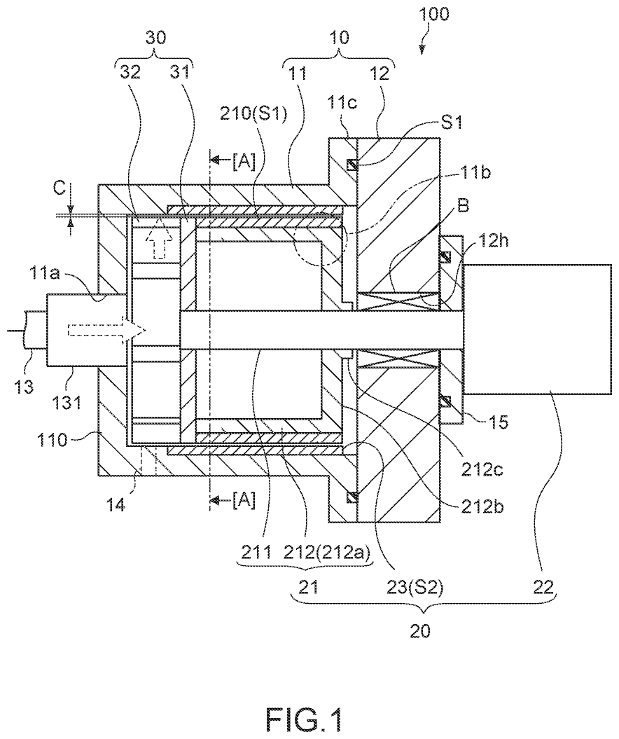

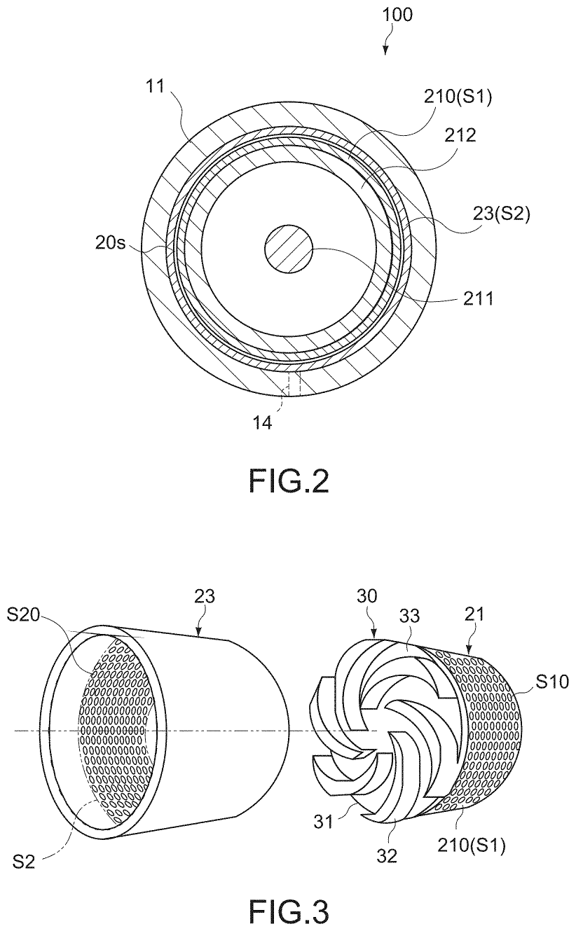

FIG. 1 is a schematic vertical cross-sectional view showing a configuration of a production apparatus 100 for a liquid containing gas bubbles according to this embodiment. FIG. 2 is a cross-sectional view taken in the line direction [A]-[A] in FIG. 1.

The production apparatus 100 for a liquid containing gas bubbles according to this embodiment is an apparatus that produces a liquid containing fine gas bubbles (hereinafter, a liquid containing gas bubbles). The gas bubbles includes, as to the kind, ultra-fine bubbles (UFB) having a diameter of 1 μm or less, micro bubbles having a diameter of 10 μm or less, milli-bubbles having a diameter of 1 mm or less, and the like, depending on the size. Although the gas bubbles that the liquid containing gas bubbles contains may have any size, the gas bubbles that the liquid containing gas bubbles contains are typically UFB.

A gas to form the gas bubbles is not particularly limited, and can be, for example, the air, nitrogen, oxygen, ozone, or the like. A liquid that constitutes the liquid containing gas bubbles is not particularly limited, and can be selected as appropriate depending on purposes. The application examples will be described later.

As shown in FIG. 1, the production apparatus 100 for a liquid containing gas bubbles according to this embodiment includes a casing 10, a shearing mechanism unit 20, and a pump unit 30.

(Casing)

The casing 10 is made from a metal material or a synthetic resin material and includes an inlet 11a and an outlet 11b. The inlet 11a and the outlet 11b are in communication with each other through the inside of the casing 10. The liquid containing gas bubbles is fed into the inlet 11a. The liquid having the gas bubbles refined in the shearing mechanism unit 20 is delivered from the outlet 11b. A joint portion 131 of a feed pipe 13 is connected to the inlet 11a. A joint portion (not shown) of a delivery pipe is connected to the outlet 11b. The outlet 11b is favorably connected to a discharge pipe extending horizontally. Accordingly, the air can be prevented from remaining in the vicinity of the outlet 11b.

The feed pipe 13 connected to the inlet 11a is connected to a tank (not shown). The tank reserves a liquid that constitutes the liquid containing gas bubbles. A gas injection pipe that injects a gas into the liquid taken in from the tank is connected to the feed pipe 13. The liquid containing gas bubbles is fed into the inlet 11a through the gas injection pipe. On the other hand, the delivery pipe connected to the outlet 11b is also connected to the tank. The liquid containing gas bubbles produced by the production apparatus 100 for a liquid containing gas bubbles is made to flow into the tank.

It should be noted that the joint portion 131 may be constituted by a gas injection pipe such as a Venturi tube. In this case, the configuration of the production system for a liquid containing gas bubbles can be simplified because it is unnecessary to provide the feed pipe 13 with an additional gas injection pipe.

The casing 10 includes a casing main body 11 constituted by a bottomed cylindrical shape that is opened at one end and a lid portion 12 that closes the opening of the casing main body 11 in a liquid-tight manner. The inlet 11a is provided at the center of a bottom portion 110 of the casing main body 11. The outlet 11b is provided in a side peripheral portion of the casing main body 11. The lid portion 12 has a disk shape and is fixed to a flange portion 11c provided in the opening end portion of the casing main body 11 via a seal ring S1 with a plurality of fixtures (not shown). A drain hole 14 for draining water and a plug (not shown) that closes it are respectively provided at appropriate positions of the side peripheral portion of the casing main body 11.

(Shearing Mechanism Unit)

The shearing mechanism unit 20 includes a rotor 21, a motor 22 serving as a rotation applying unit, and a facing member 23. FIG. 3 is a perspective view showing the rotor 21 and the facing member 23.

As will be described later, the shearing mechanism unit 20 is configured to apply shearing force to a liquid flowing to the outlet 11b from the inlet 11a in an annular shearing chamber 20s formed between a first structure surface S1 of the rotor 21 and a second structure surface S2 of the facing member 23, to thereby refine gas bubbles in the liquid.

The rotor 21 includes a rotary shaft 211 and a cylindrical portion 212 serving as a tube portion. The rotary shaft 211 extends along the axial center of the casing main body 11 and is rotatably supported through a bearing member B fixed in a center hole 12h of the lid portion 12. The center hole 12h of the lid portion 12 is closed by a cover 15, which is placed in an outer surface of the lid portion 12, in a liquid-tight manner.

The cylindrical portion 212 is attached on a one end side of the rotary shaft 211 and is typically made from a metal material. In this embodiment, the cylindrical portion 212 is made from a light-weight metal material such as aluminum and titanium and is formed in a bottomed cylindrical shape that is opened on the side of the inlet 11a. Accordingly, since the cylindrical portion 212 can be reduced in weight, the load of the motor 22 can be reduced. It should be noted that the cylindrical portion 212 is not limited to the hollow structure, and may have a solid structure.

The cylindrical portion 212 includes a peripheral wall 212a and a bottom portion 212b. A cylindrical tubular member 210 having, as the outer peripheral portion, the first structure surface S1 in which a plurality of recess portions S10 (see FIG. 3) is formed is integrally attached to the outer peripheral portion of the peripheral wall 212a. The tubular member 210 is typically made from a metal material such as aluminum. The rotary shaft 211 penetrates a center portion of the bottom portion 212b and a boss portion 212c, which is integrally fixed to the rotary shaft 211, is provided.

The first structure surface S1 is a cylindrical curved surface having the rotary shaft 211 as the axial center and is an irregular surface formed in an outer peripheral portion of the tubular member 210 that faces the facing member 23. The diameter of the tubular member 210 is not particularly limited, and for example, is 150 mm or more and 200 mm or less. The axial length of the tubular member 210 is also not particularly limited, and is about 80 mm in this embodiment.

The motor 22 is attached on the other end side of the rotary shaft 211 and applies rotating force around the rotary shaft 211 to the rotor 21. The motor 22 is disposed outside the casing 10. In this embodiment, the motor 22 is placed in an outer surface of the cover 15. A drive shaft of the motor 22 is coupled with the rotary shaft 211 of the rotor 21 or configured to be integral with the rotary shaft 211 of the rotor 21.

The motor 22 is typically constituted by an electric motor having a variable number of revolutions. The number of revolutions is not particularly limited, and can be arbitrarily set in accordance with the size of gas bubbles to be refined, the flow rate of the liquid, and the like. for example, the number of revolutions is 1000 rpm or more and 8000 rpm or less. In this embodiment, the number of revolutions is 3000 rpm.

The facing member 23 is a cylindrical member provided in an inner wall portion of the casing 10. The facing member 23 has an inner peripheral portion that faces the first structure surface S1 formed in the outer peripheral portion of the rotor 21 (the outer peripheral portion of the tubular member 210) via a predetermined clearance C.

The inner peripheral portion of the facing member 23 constitutes a second structure surface S2 in which a plurality of recess portions S20 (see FIG. 3) is formed. The second structure surface S2 is a cylindrical curved surface coaxial with the tubular member 210. The second structure surface S2 is an irregular surface formed in the inner peripheral portion of the facing member 23 that faces the first structure surface S1. The clearance C between the first structure surface S1 and the second structure surface S2 is constant over the entire peripheries of the first structure surface S1 and the second structure surface S2. An annular space portion formed between the first structure surface S1 and the second structure surface S2 is formed as the shearing chamber 20s.

The shearing chamber 20s is formed to have a cross-sectional area larger than a flow-channel cross-sectional area of the feed pipe 13 connected to the inlet 11a (a cross-sectional area perpendicular to the axial direction of the feed pipe 13). Accordingly, the pressure drop of the liquid that passes through the shearing chamber 20s can be reduced and a desired flow rate can be ensured. The cross-sectional area of the shearing chamber 20s can be adjusted with the size of the clearance C.

As shown in FIG. 3, recess portions S10 of the first structure surface S1 and recess portions S20 of the second structure surface S2 are constituted by pluralities of circular dimples formed in the cylindrical curved surfaces, respectively. In this embodiment, the recess portions S10 and S20 are each formed with the same size and depth, though not limited thereto as a matter of course. The recess portions S10 and S20 may be formed with different sizes and depths. The sizes and depths of the recess portions S10 and S20 are not particularly limited, and in this embodiment, the diameter is about 3 mm and the depth is about 1.7 mm.

The recess portions S10 are formed at predetermined pitches (arrangement intervals) in the axial direction and the circumferential direction of the cylindrical portion 212. Similarly, the recess portions S20 are formed at the predetermined pitches (arrangement intervals) in the axial direction and the circumferential direction of the facing member 23. The arrangement intervals of the recess portions S10 and S20 are not particularly limited, and for example, are 1 mm.

The forming method for the recess portions S10 and S20 is not particularly limited, and for example, mechanical working, transferring, laser working, etching working, or the like can be employed. More favorably, edges of openings of the recess portions S10 and S20 are closer to the right angle. Accordingly, the shearing load to the liquid due to the relative rotation between the first structure surface S1 and the second structure surface S2 can be more efficiently applied.

The recess portions S10 and S20 are not limited to the circular dimple shapes, and may be polygonal shapes such as triangular or rectangular shapes. In particular, in a case where a hexagonal honeycomb structure is employed, the plurality of recess portions can be formed with a high density. Moreover, the recess portions S10 and S20 are not limited to independent shapes, and those having various shapes that can form an irregular surface, like a grid shape, a radial shape, or the like can be employed.

The fixation method for the tubular member 210 having the first structure surface S1 is not particularly limited, and may be, for example, press-fitting into the cylindrical portion 212, adhesion with a bonding material, or the like. Alternatively, threads that are engaged with each other may be formed in the outer peripheral portion of the cylindrical portion 212 and the inner peripheral portion of the tubular member 210. The first structure surface S1 may be directly provided in the outer peripheral portion of the cylindrical portion 212. In this case, the tubular member 210 becomes unnecessary, and the number of components that constitute the rotor 21 can be reduced.

On the other hand, the facing member 23 is fixed to the inner peripheral portion of the casing main body 11. The fixation method is not particularly limited, and may be, for example, press-fitting, adhesion with a bonding material, or the like. Alternatively, threads that are engaged with each other may be formed in the inner peripheral portion of the casing main body 11 and the outer peripheral portion of the facing member 23. In addition, the facing member 23 may be provided as a part of the casing main body 11. In this case, the second structure surface S2 may be directly formed in the inner peripheral portion of the casing main body 11.

The clearance C between the first structure surface S1 and the second structure surface S2 is not particularly limited, and is set as appropriate in accordance with the type/kind and the flow rate of the liquid, the number of revolutions or the rotation speed of the rotor 21, and the like. For example, in a case where the liquid is water, the size of the clearance C is 1.0 mm or more and 3.0 mm or less and is more favorably 1.5 mm or more and 2.5 mm or less. In a case where the clearance C is smaller than 1.0 mm, the pressure loss of the liquid tends to increase and the flow rate of the liquid discharged from the outlet 11b tends to lower. On the other hand, in a case where the clearance C exceeds 3.0 mm, the shearing stress that acts on the liquid between the first structure surface S1 and the second structure surface S2 lowers and, for example, it tends to be difficult to refine gas bubbles to a size of 1 μm or less. The clearance C is typically adjusted with the thicknesses of the tubular member 210 and the facing member 23.

(Pump Unit)

The pump unit 30 is configured to be capable of transporting a liquid to the outlet 11b from the inlet 11a by driving of the motor 22.

The pump unit 30 includes a base 31 and a plurality of blade portions 32. The base 31 rotates integrally with the rotor 21 by being fixed to an end portion located on the opening side of the cylindrical portion 212 (end portion located on the side of the inlet 11a). The base 31 has a disk shape having an outer diameter identical to the tubular member 210 having the first structure surface S1 and is typically made from a metal material as in the rotor 21. The plurality of blade portions 32 is integrally provided in the base 31 so as to protrude to the inlet 11a. The plurality of blade portions 32 is, as shown in FIG. 3, formed to radially extend curving to the circumferential portion from the center portion of the base 31.

The pump unit 30 constitutes a centrifugal pump (radial flow pump) and the plurality of blade portions 32 corresponds to a centrifugal impeller. That is, the pump unit 30 produces liquid flow in the radial direction from the center (rotational axis center) of the base 31. The plurality of blade portions 32 gives rotation to the liquid to increase the energy and produces a discharge pressure for transporting the liquid to the shearing chamber 20s, and then the outlet 11b, from the inlet 11a.

In this embodiment, the blade portions 32 are formed to have streamline shapes so that the widths increase to the outer peripheral side from the inner peripheral side. Accordingly, since it is possible to ensure sufficient widths of flow channels 33 (see FIG. 3) for the liquid, which are formed between the blade portions 32, and to make the widths of the flow channels 33 uniform, the resistance to the liquid that flows through the flow channels 33 can be reduced.

Although the outer diameters and heights of the blade portions 32 (projection heights from the base 31) are also not particularly limited, a larger discharge pressure can be obtained as the blade portions 32 have larger outer diameters and heights. The outer diameters of the blade portions 32 are typically set to the same size (e.g., 150 mm to 200 mm) as the outer diameter of the base 31. In this case, the heights of the blade portions 32 can be 20 mm or more and 40 mm or less. Accordingly, for example, under the condition where the flow rate is 40 L/min and the number of revolutions is 3000 rpm, a discharge pressure of 0.18 MPa to 0.43 Mpa can be obtained.

Since the production apparatus 100 for a liquid containing gas bubbles according to this embodiment includes the pump unit 30, it becomes unnecessary to provide a hydraulic pump in a piping system that feeds a liquid into the inlet 11a. Thus, the system can be simplified.

[Operation of Production Apparatus for Liquid Containing Gas Bubbles]

Next, an operation of the production apparatus 100 for a liquid containing gas bubbles according to this embodiment, which is configured in the above-mentioned manner, will be described.

The motor 22 is activated and the rotor 21 rotates a predetermined number of revolutions (e.g., 3000 rpm). Accordingly, the pump unit 30 rotates together with the rotor 21 and takes in a liquid from the tank (not shown). After the gas injection pipe connected to the feed pipe 13 injects a gas into the liquid taken in from the tank, the liquid with the gas is introduced into the inlet 11a.

The liquid introduced into the inlet 11a undergoes the rotating action provided by the pump unit 30 and is supplied into the shearing chamber 20s at a predetermined discharge pressure. In the shearing chamber 20s, the first structure surface S1 of the rotor 21 relatively rotates with respect to the second structure surface S2 of the facing member 23. The liquid supplied into the shearing chamber 20s receives centrifugal force due to the rotating action provided by the pump 30 and receives shearing stress between the first structure surface S1 and the second structure surface S2 that relatively rotate with respect to each other, so that gas bubbles in the liquid are refined. The generated liquid containing gas bubbles are delivered from the outlet 11b.

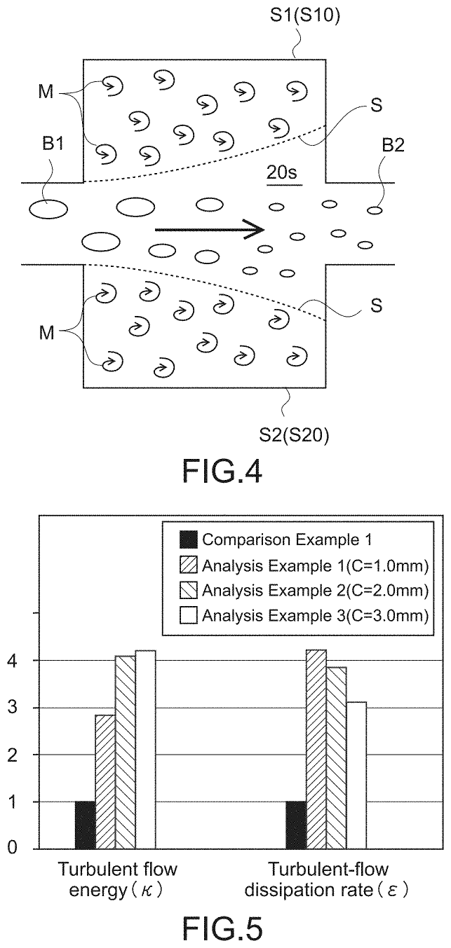

FIG. 4 is a schematic view showing a state of the liquid containing gas bubbles that flows between the first structure surface S1 and the second structure surface S2 in the shearing chamber 20s. When a liquid including a gas bubble B1 flows in the arrow direction as shown in FIG. 4, the first structure surface S1 and the second structure surface S2 that relatively rotate with respect to each other apply shearing stress and jet streams of the liquid containing gas bubbles are generated inside the recess portions S10 and S20. In FIG. 4, regions in which the jet streams are generated are shown as the lines S. In each of the recess portions S10 and S20, these jet streams generate relatively small vortices M and act on the gas bubble B1. Accordingly, the gas bubble B1 is refined into the gas bubble B2.

In particular, in this embodiment, it is configured to apply shearing force to a liquid between the two irregular surfaces, the first structure surface S1 and the second structure surface S2. Therefore, shearing can be performed in a state in which these structure surfaces S1 and S2 securely sandwiches the liquid. Therefore, very high shearing energy can be applied to the liquid as compared to a case where a single irregular surface is provided. Accordingly, refinement of gas bubbles can be efficiently promoted.

It should be noted that the area of the first structure surface S1 (and the second structure surface S2) may be extended by increasing the axial length of the tubular member 210 in the rotor 21. Accordingly, the time or distance in/by which the shearing force is applied during the process in which the liquid reaches the outlet 11b from the inlet 11a increases. Therefore, the efficiency of generation of minute gas bubbles can be further improved and the amount of generation of UFB can be greatly increased.

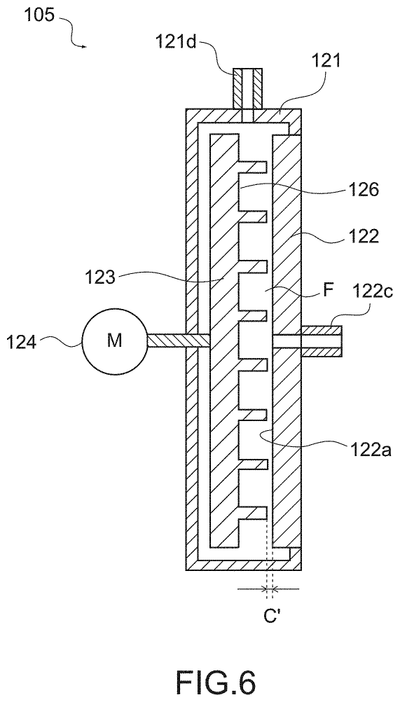

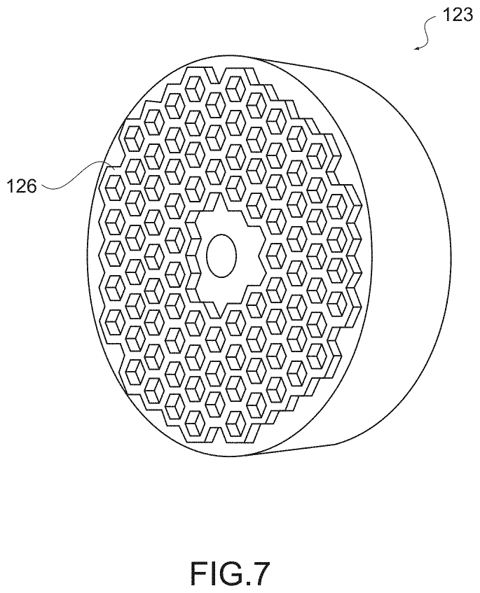

FIG. 5 is simulation results performed using fluid analysis software and shows a relationship between the size of the clearance C between the first structure surface S1 and the second structure surface S2 and turbulent flow energy (κ) and turbulent-flow dissipation rate (ε). Here, characteristics of the production apparatus 100 for a liquid containing gas bubbles according to this embodiment were assessed as compared to a production apparatus 105 having the structure shown in FIGS. 6 and 7.

FIG. 6 is a configuration of a vertical cross-sectional view showing the production apparatus 105 according to Comparison Example 1. FIG. 7 is a schematic perspective view of a rotating plate 123 in the production apparatus 105. Hereinafter, the production apparatus 105 according to Comparison Example 1 will be described.

As shown in FIG. 6, the production apparatus 105 according to Comparison Example 1 rotates the rotating plate 123 having a diameter of 150 mm, which is disposed inside a casing 121, through a motor 124 and applies shearing force to a liquid between an irregular surface 126 formed in the surface of the rotating plate 123 and a facing member 122 that faces this irregular surface 126 via a predetermined clearance C′, to thereby produce liquid containing gas bubbles. As shown in FIG. 7, the irregular surface 126 of the rotating plate 123 is a honeycomb-structure surface in which a plurality of hexagonal recess portions is formed and a surface 122a of the facing member 122 that faces the irregular surface 126 is a flat surface. A shearing chamber F that applies shearing force to the liquid introduced from an inlet 122c formed in a center portion of the facing member and generates a liquid containing gas bubbles is formed between the irregular surface 126 and the facing member 122 and is configured to deliver the generated liquid containing gas bubbles from an outlet 121d formed in a side peripheral portion of the casing 121.

In the production apparatus 105 according to Comparison Example 1 having the above-mentioned configuration, the turbulent flow energy (κ) and the turbulent-flow dissipation rate (ε) in the shearing chamber F were measured after setting the number of revolutions of the rotating plate 123 to 3000 rpm, the flow rate of the liquid fed from the inlet 122c to 40 L/min, and the size of the clearance C′ to 1 mm. On the other hand, in the production apparatus 100 for a liquid containing gas bubbles according to this embodiment shown in FIG. 1, the turbulent flow energy (κ) and the turbulent-flow dissipation rate (ε) in the shearing chamber 20s were measured after setting the number of revolutions of the rotor 21 to 3000 rpm, the flow rate of the liquid fed from the inlet 11a to 40 L/min, the size of the clearance C to 1 mm (Analysis Example 1), 2 mm (Analysis Example 2), and 3 mm (Analysis Example 3). It should be noted that in Analysis Examples 1 to 3, the diameter of the rotor 21 was set to 150 mm and the axial length of the tubular member 210 in the rotor 21 was set to 80 mm.

Here, the turbulent flow energy (κ) represents the level of turbulence of the flow and the turbulent-flow dissipation rate (ε) represents the rate at which the turbulence disappears. As the value of the turbulent-flow dissipation rate becomes larger, it means that smaller vortices are generated. It is considered that these characteristic values greatly affect the ability to generate the liquid containing gas bubbles, and the turbulent flow energy (κ) is related to the total refinement level of gas bubbles and the turbulent-flow dissipation rate (ε) is related to sizes of vortices, that is, refinement levels of gas bubbles.

FIG. 5 shows measurement values in Analysis Examples 1 to 3 when the measurement value in Comparison Example 1 is defined as 1. As shown in FIG. 5, in accordance with Analysis Examples 1 to 3, the turbulent flow energy (κ) and the turbulent-flow dissipation rate (c) higher than those of Comparison Example 1 are obtained. Therefore, in accordance with the production apparatus 100 for a liquid containing gas bubbles according to this embodiment, the production apparatuses according to Analysis Examples 1 to 3 have extremely higher ability to generate the liquid containing gas bubbles than the production apparatus 105 according to Comparison Example 1.

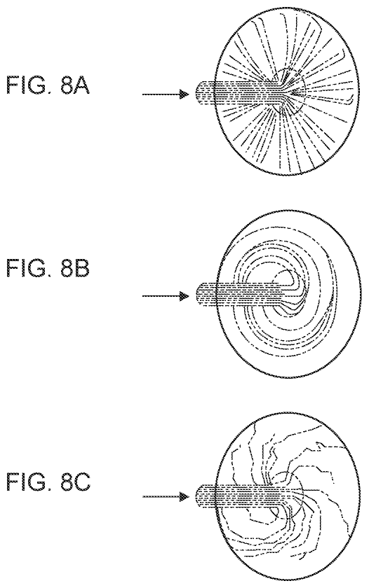

The reason why the characteristic values of the production apparatus according to Comparison Example 1 are lower than those of Analysis Examples 1 to 3 can be because the energy of the rotational flow of the liquid in the shearing chamber F cannot be sufficiently used. For example, as schematically shown in FIG. 8A, from the viewpoint of the facing member 122 that is a fixed surface, the streamlines of the liquid, which were radial when the rotating plate 123 was not rotating, change into strong rotational flow as shown in FIG. 8B due to the rotation of the rotating plate 123. However, from the viewpoint of the rotating plate 123, as shown in FIG. 8C, the streamlines of the liquid draw a few rotational trajectories while the streamlines that pass through the recess portions of the irregular surface 126 are limited due to the rotation of the rotating plate 123 with the flow. It can be because although the irregular surface 126 becomes large resistance to the liquid and produces strong rotational flow, the rotational flow does not spread over the entire region of the irregular surface 126.

In contrast, in accordance with the production apparatus 100 for a liquid containing gas bubbles according to this embodiment, since a tubular space coaxial with the axial center (rotary shaft 211) of the rotor 21 is formed as the shearing chamber 20s, a helical rotational flow of the liquid to the outlet 11b from the inlet 11a can be formed. Accordingly, the number of streamlines that pass through the recess portions S10 and S20 of the first structure surface S1 and the second structure surface S2 can be greatly increased. Therefore, we infer that larger characteristic values (the turbulent flow energy (κ) and the turbulent-flow dissipation rate (ε)) can be obtained by applying, to the liquid, shearing force stronger than that of Comparison Example 1.

In addition, in this embodiment, the shearing chamber 20s is constituted by the space sandwiched by the two irregular surfaces, the first structure surface S1 and the second structure surface S2. Therefore, strong shearing force can be effectively applied to the liquid in the shearing chamber 20s. Therefore, a liquid containing gas bubbles having higher UFB-containing density than that of Comparison Example 1 can be efficiently generated.

It should be noted that as compared to Analysis Examples 1 to 3, as the clearance C becomes larger, the turbulent flow energy (κ) tends to increase while the turbulent-flow dissipation rate (ε) tends to decrease. Therefore, out of these analysis examples, it is judged that Analysis Example 2 (clearance C=2 mm) in which the turbulent flow energy (κ) and the turbulent-flow dissipation rate (ε) both take relatively high values is an optimal value.

It should be noted that although the production apparatus 100 for a liquid containing gas bubbles according to this embodiment includes the second structure surface S2 in the facing member 23, the second structure surface S2 may be omitted. That is, the surface of the facing member 23 that faces the first structure surface S1 may be a smooth cylindrical surface.

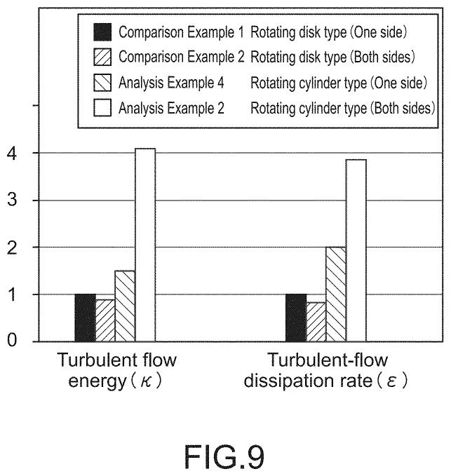

FIG. 9 shows simulation results of characteristics of the production apparatus (Analysis Example 4) without the second structure surface S2 and the production apparatus 105 according to Comparison Example 1 described with reference to FIGS. 6 and 7 in comparison with each other. In addition, FIG. 9 respectively shows characteristics of the production apparatus according to Analysis Example 2 and a production apparatus (Comparison Example 2) in which the surface 122a of the facing member 122 in Comparison Example 1 is constituted by an irregular surface similar to the irregular surface 126. FIG. 9 also shows characteristic values of Comparison Example 2 and Analysis Examples 2 and 4 as relative values when the measurement value in Comparison Example 1 are defined as 1. It should be noted that the clearance between the rotating member 126 and the facing member 122 was set to 1 mm in Comparison Example 2 as in Comparison Example 1, and the clearance between the first structure surface S1 and the facing member 23 was set to 1 mm in Analysis Example 4. Moreover, the number of revolutions and the flow rate were set to 3000 rpm and 40 L/min, respectively.

As shown in FIG. 9, also in Analysis Example 4, we confirmed that turbulent flow energy (κ) and turbulent-flow dissipation rate (ε) higher than those of Comparison Examples 1 and 2 can be obtained. Moreover, as it will be obvious from comparison of Analysis Example 2 with Analysis Example 4, we confirmed that Analysis Example 2 with the second structure surface S2 can provide turbulent flow energy (κ) and turbulent-flow dissipation rate (ε) higher than those of Analysis Example 4 without the second structure surface S2.

(Modified Example of Pump Unit)

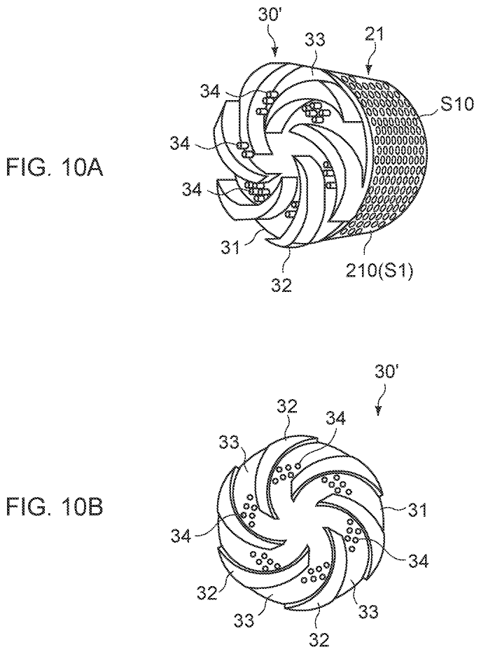

The pump unit 30 is not limited to the configuration shown in FIG. 3, and a configuration as shown in FIGS. 10A and B may be employed. FIG. 10A is a perspective view of a pump unit 30′. FIG. 10B is a front view of the pump unit 30′.

The pump unit 30′ shown in FIGS. 10A and B has a plurality of protrusion portions 34 formed between the plurality of blade portions 32. The plurality of protrusion portions 34 is provided in the flow channels 33 formed between the plurality of blade portions 32 and protrudes from the surface of the base 31 with a predetermined height. By the plurality of protrusion portions 34 being disposed in the flow channels 33 respectively, gas bubbles in the liquid flowing through the flow channels 33 can be dispersed and refinement of gas bubbles in the shearing chamber 20s can be efficiently performed.

The shape of each protrusion portion 34 is not particularly limited. The protrusion portion 34 has, for example, a diameter of 3 mm to 4 mm and a height of about 10 mm. The number of protrusion portions 34 and the intervals of the protrusion portions 34 are also not particularly limited, and can be arbitrarily set.

The protrusion portions 34 are not limited to the example in which the protrusion portions 34 are provided in the flow channels 33. For example, the protrusion portions 34 may be provided in the side surfaces of the blade portions 32. Alternatively, the protrusion portions 34 may be replaced by recess portions. Such a configuration can also provide actions and effects similar to those described above.

### Second Embodiment

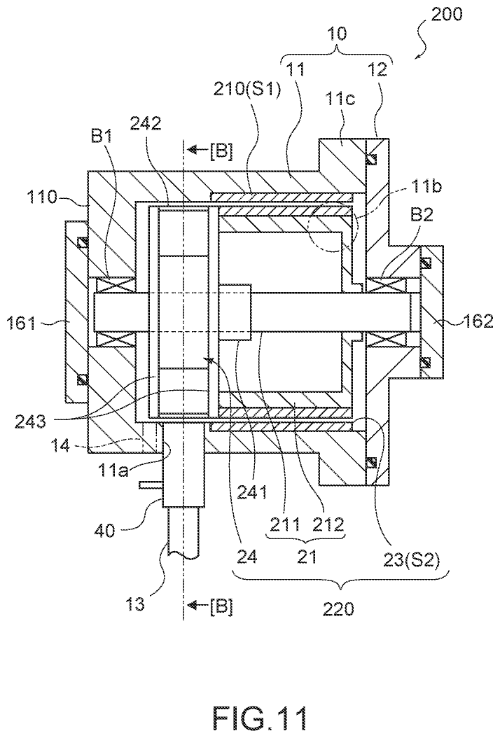

Next, a second embodiment of the present invention will be described. FIG. 11 is a schematic cross-sectional view of a production apparatus 200 for a liquid containing gas bubbles according to the second embodiment of the present invention. Hereinafter, configurations different from those of the first embodiment will be mainly described, configurations similar to those of the first embodiment will be denoted by similar reference signs, and descriptions thereof will be omitted or simplified.

The production apparatus 200 for a liquid containing gas bubbles according to this embodiment is different from that of the first embodiment in that the production apparatus 200 for a liquid containing gas bubbles according to this embodiment includes a casing 10 and a shearing mechanism unit 220 and a rotation applying unit of the shearing mechanism unit 220 is constituted by an impeller 24.

The impeller 24 is provided in a rotary shaft 211 and applies rotating force around the rotary shaft 211 to a rotor 21. The impeller 24 is disposed inside the casing 10 and is configured to rotate by receiving the pressure of a liquid introduced into an inlet 11a. Accordingly, the rotor 21 can be rotated without a driving source such as a motor.

In this embodiment, one end of the rotary shaft 211 is rotatably supported through a bearing member B1 fixed to a central hole of a bottom portion 110 of a casing main body 11 and the other end of the rotary shaft 211 is rotatably supported through a bearing member B2 fixed in a central hole of a lid portion 12. The central hole of the bottom portion 110 of the casing main body 11 and the central hole of the lid portion 12 are closed by covers 161 and 162 in a liquid-tight manner, respectively. The inlet 11a and an outlet 11b are each provided in the side peripheral portion of the casing main body 11. A feed pipe 13 is connected to the inlet 11a via a gas injection unit 40 that injects a gas into a liquid introduced into the inlet 11a, such as a Venturi tube.

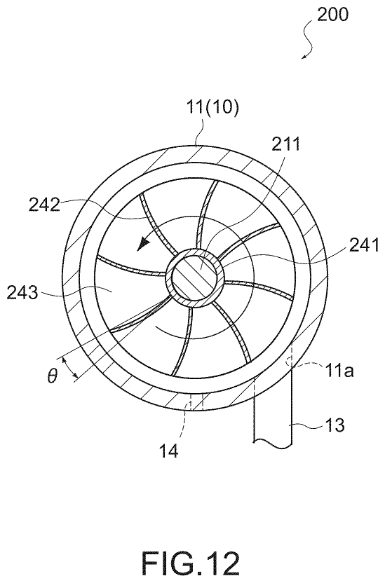

FIG. 12 is a cross-sectional view taken in the line direction [B]-[B] in FIG. 11. The impeller 24 includes a hub portion 241 integrally attached to the rotary shaft 211, a plurality of blade portions 242 radially extending from a peripheral surface of the hub portion 241, and a pair of circular supporting plates 243 that supports the plurality of blade portions 242 in an axial direction of the hub portion 241. Although the hub portion 241, the blade portions 242, and the supporting plates 243 are typically made from a metal material, the hub portion 241, the blade portions 242, and the supporting plates 243 may be made from a synthetic resin material. The metal material is favorably a relatively light-weight material such as aluminum and titanium.

The number of blade portions 242 and the skew angles of the blade portions 242 are not particularly limited, and can be set as appropriate in accordance with the flow rate of the liquid introduced into the inlet 11a and the like. In this embodiment, the number of blade portions 242 is eight and the skew angle θ is set to fall in a range of 0° to 45°.

The impeller 24 rotates by receiving the pressure of the liquid introduced into the inlet 11a in a manner as described above. Then, the rotation driving force is transmitted to a cylindrical portion 212 via the rotary shaft 211. Accordingly, a first structure surface S1 relatively rotates with respect to a second structure surface S2. The clearance between the first structure surface S1 and the second structure surface S2 is favorably 1.5 mm or more and 2.5 mm or less as in the first embodiment. The direction of rotation of the impeller 24 is not particularly limited, and in this embodiment, the impeller 24 is configured to rotate in the counter-clockwise direction in FIG. 12. The number of revolutions (rotation speed) of the rotor 21 can be arbitrarily adjusted in accordance with the diameter of the impeller 24, the number of blade portions 242, the width sizes and the skew angles θ of the blade portions 242, the flow rate of the liquid introduced into the inlet 11a, and the like.

For example, assuming that the diameter of the impeller 24 is 150 mm to 200 mm, the number of blade portions 242 is eight, the widths of the blade portions 242 are 10 mm, the skew angles θ of the blade portions 242 are 10°, and the rotation efficiency is 0.7, the number of revolutions of 200 rpm is obtained when the flow rate is 20 L/min, the number of revolutions of 400 rpm is obtained when the flow rate is 40 L/min, and the number of revolutions of 600 rpm is obtained when the flow rate is 60 L/min as trial calculation results. A structure like propeller's blades, for example, can be employed for the impeller 24 other than the above-mentioned structure like a water turbine.

This embodiment can also provide actions and effects similar to those of the first embodiment. In accordance with this embodiment, since the gas injection unit 40 is connected to the inlet 11a, the feed pipe 13 may be attached to an outlet port of a hydraulic pump, a water line faucet, or the like. In this case, the discharge pressure of the hydraulic pump or the tap water pressure rotates the impeller 24 and the first structure surface S1 and the second structure surface S2 applies predetermined shearing force to a liquid containing gas bubbles. Therefore, such a configuration can also produce a liquid containing gas bubbles that contains a large amount of minute gas bubbles.

### Third Embodiment

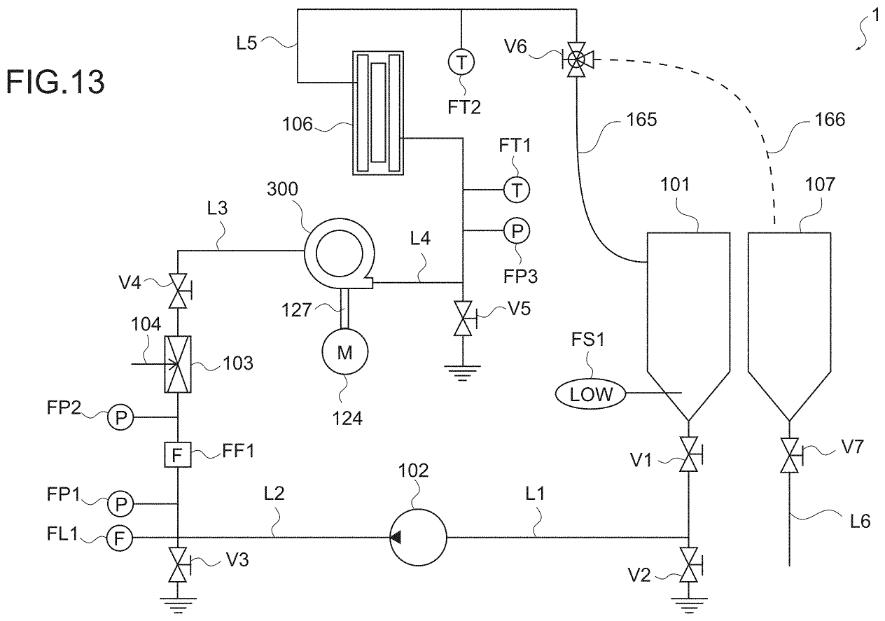

Next, a third embodiment of the present invention will be described. FIG. 13 is a schematic view showing a configuration of a production system 1 for a liquid containing gas bubbles according to this embodiment. As shown in the figure, the production system 1 for a liquid containing gas bubbles includes a circulation tank 101, a hydraulic pump 102, a gas injection unit 103, a gas injection line 104, a production apparatus 300 for a liquid containing gas bubbles, a heat exchanger 106, and a finishing tank 107.

The gas to form the gas bubbles is not particularly limited, and can be, for example, the air, N₂, O₂, O₃, or the like. Alternatively, the liquid containing gas bubbles may contain gas bubbles formed by different kinds of gases. Although the liquid that constitutes the liquid containing gas bubbles is not particularly limited, the liquid that constitutes the liquid containing gas bubbles is typically water.

[Configuration of Production System for Liquid Containing Gas Bubbles]

The circulation tank 101 reserves a stock solution or an unfinished liquid containing gas bubbles. The circulation tank 101 is provided with a liquid level gauge FS1 that measures the amount of liquid in the circulation tank 101. The circulation tank 101 is connected to the hydraulic pump 102 through a piping L1. A liquid supply valve V1 and a liquid discharge valve V2 are connected to the piping L1.

The hydraulic pump 102 is connected to the gas injection unit 103 through a piping L2. The hydraulic pump 102 pumps a liquid, which is supplied from the circulation tank 101 via the piping L1, into the gas injection unit 103 via the piping L2. A pressure/flow rate adjustment valve V3, a flowmeter FL1, a pressure gauge FP1, a filter FF1, and a pressure gauge FP2 are connected to the piping L2. The filter FF1 is a filter for removing impurities from the liquid flowing through the piping L2.

The gas injection unit 103 is a pipe having a narrow-diameter portion. The liquid supplied from the piping L2 increases in flow velocity at the narrow-diameter portion and its pressure temporarily lowers. The gas injection unit 103 may be a Venturi tube.

The gas injection line 104 connects the narrow-diameter portion of the gas injection unit 103 to a gas source such as a gas cylinder and injects the gas into the liquid flowing through the narrow-diameter portion. Due to the connection of the gas injection line 104 to the gas injection unit 103, the gas injection pressure can be lowered.

The gas injection unit 103 is connected to the production apparatus 300 for a liquid containing gas bubbles via a piping L3 and supplies the liquid with the gas injected therein into the production apparatus 300 for a liquid containing gas bubbles. A pressure/flow rate adjustment valve V4 is connected to the piping L3.

The production apparatus 300 for a liquid containing gas bubbles refines gas bubbles of a gas contained in the liquid supplied from the piping L3 and generates a liquid containing gas bubbles that contains minute gas bubbles. A configuration of the production apparatus 300 for a liquid containing gas bubbles will be described later. The production apparatus 300 for a liquid containing gas bubbles is connected to the heat exchanger 106 through a piping L4. A pressure/flow rate adjustment valve V5, a pressure gauge FP3, and a thermometer FT1 are connected to the piping L4.

The heat exchanger 106 cools the liquid containing gas bubbles supplied from the piping L4. It is because the liquid containing gas bubbles is at high temperature particularly due to passing through the production apparatus 300 for a liquid containing gas bubbles. The structure of the heat exchanger 106 is not particularly limited. The heat exchanger 106 is connected to a three-way valve V6 through a piping L5. A thermometer FT2 is connected to the piping L5.

The three-way valve V6 connects the piping L5 to a circulation line 165 or a finishing line 166. The circulation line 165 connects the three-way valve V6 to the circulation tank 101 and the finishing line 166 connects the three-way valve V6 to the finishing tank 107.

The finishing tank 107 reserves the finished liquid containing gas bubbles. A piping L6 is connected to the finishing tank 107 and a liquid discharge valve V7 is connected to the piping L6.

[Configuration of Production Apparatus for Liquid Containing Gas Bubbles]

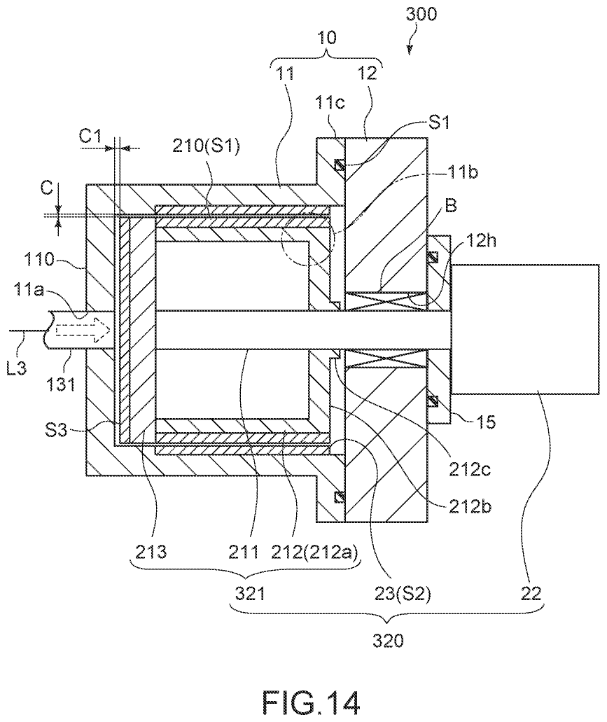

Next, the configuration of the production apparatus 300 for a liquid containing gas bubbles according to this embodiment will be described. FIG. 14 is a schematic cross-sectional view of the production apparatus 300 for a liquid containing gas bubbles. It should be noted that in FIG. 14, portions common to those of the above-mentioned first embodiment will be denoted by the same reference signs and detailed descriptions thereof will be omitted.

The production apparatus 300 for a liquid containing gas bubbles according to this embodiment is different from that of the first embodiment in that the production apparatus 300 for a liquid containing gas bubbles according to this embodiment includes a casing 10 and a shearing mechanism unit 320 and also includes a disk member 213 having a third structure surface S3 instead of the pump unit 30.

In this embodiment, the shearing mechanism unit 320 includes a rotor 321, a motor 22, and a facing member 23. The rotor 321 includes a rotary shaft 211, a cylindrical portion 212, and the disk member 213.

The disk member 213 is fixed in an opening of the cylindrical portion 212. The disk member 213 has an outer diameter identical to an outer diameter of the cylindrical portion 212 and closes the opening of the cylindrical portion 212. The disk member 213 faces an inner surface of a bottom portion 110 of the casing main body 11 via a predetermined clearance C1. The disk member 213 is fixed to an end of the rotary shaft 211 and is configured to be rotatable integrally with the cylindrical portion 212 by driving of the motor 22.

The third structure surface S3 is a circular flat surface orthogonal to the rotary shaft 211 and is an irregular surface formed in the surface of the disk member 213 that faces the bottom portion 110 of the casing main body 11. As in the irregular surface 126 described with reference to FIG. 7, the third structure surface S3 is, for example, constituted by a honeycomb structure surface in which a plurality of hexagonal recess portions is formed. The inner surface of the bottom portion 110 of the casing main body 11 that faces the third structure surface S3 is typically a flat surface, though not limited thereto. The inner surface of the bottom portion 110 of the casing main body 11 may be an irregular surface similar to the third structure surface S3.

The clearance C1 between the third structure surface S3 and the inner surface of the bottom portion 110 of the casing main body 11 is favorably 0.5 mm or more and 1.5 mm or less, for example. The number of revolutions of the motor 22 is, for example, 1000 rpm or more and 8000 rpm or less as in the first embodiment.

[Operation of Production System for Liquid Containing Gas Bubbles]

Next, an operation of the production system 1 for a liquid containing gas bubbles will be described.

Referring to FIG. 13, the hydraulic pump 102 pumps a liquid from the circulation tank 101 into the gas injection unit 103 and injects a gas into the liquid from the gas injection line 104. The liquid with the gas injected therein is further pumped into the production apparatus 300 for a liquid containing gas bubbles and is introduced into the inlet 11a of the casing 10 via the feed pipe 12a and the inlet 11a (see FIG. 14).

In the production apparatus 300 for a liquid containing gas bubbles, the rotor 321 rotates around the rotary shaft 211 at a predetermined number of revolutions by driving of the motor 22. Accordingly, a first structure surface S1 of the cylindrical portion 212 relatively rotates with respect to a second structure surface S2 of the facing member 23 in a state in which the first structure surface S1 of the cylindrical portion 212 faces the second structure surface S2 of the facing member 23 via a predetermined clearance C. On the other hand, a third structure surface S3 of the disk member 213 relatively rotates with respect to the inner surface of the bottom portion 110 of the casing main body 11 in a state in which the third structure surface S3 of the disk member 213 faces the inner surface of the bottom portion 110 of the casing main body 11 via the predetermined clearance C1.

The liquid introduced into the inlet 11a of the casing 10 passes through the clearance between the third structure surface S3 and the bottom portion 110 of the casing main body 11, passes through the clearance between the first structure surface S1 and the second structure surface, and is delivered from the outlet 11b. At this time, the liquid introduced into the inlet 11a receives shearing force between the third structure surface S3 and the bottom portion 110 of the casing main body 11 and further receives shearing force between the first structure surface S1 and the second structure surface S2. Therefore, the gas bubbles contained in the liquid are efficiently refined. Accordingly, the efficiency of generation and the amount of generation of UFB can be further increased.

The liquid containing gas bubbles delivered from the production apparatus 300 for a liquid containing gas bubbles is supplied into the heat exchanger 106 via the piping L4 and is cooled by the heat exchanger 106. The liquid cooled by the heat exchanger 106 is supplied into the circulation tank 101 or the finishing tank 107 via the three-way valve V6. The liquid containing gas bubbles supplied into the circulation tank 101 is pumped by the hydraulic pump 102 to the production apparatus 300 for a liquid containing gas bubbles again. In this manner, the density of gas bubbles can be increased.

In the production system 1 for a liquid containing gas bubbles, for example, after the liquid circulated via the circulation tank 101 so as to increase the density of gas bubbles in a constant time, the generated liquid containing gas bubbles can be reserved in the finishing tank 107 by operating the three-way valve V6. Alternatively, the liquid containing gas bubbles may be reserved in the finishing tank 107 in only one cycle without using the circulation tank 101. The liquid containing gas bubbles reserved in the finishing tank 107 is discharged from the piping L6 and used.

### Fourth Embodiment

[Production System for Liquid Containing Gas Bubbles]

Since the production apparatus 100 for a liquid containing gas bubbles according to the first embodiment includes the pump unit 30 to be driven by the motor 22, a liquid containing gas bubbles can be produced in the tank without configuring a circulation line, e.g., installing it in the tank reserving the liquid or the like.

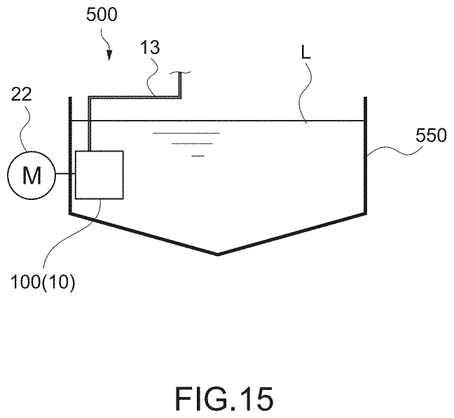

FIG. 15 is a schematic view showing a configuration of a tank unit 500 serving as a production system for a liquid containing gas bubbles including the production apparatus 100 for a liquid containing gas bubbles according to the first embodiment. As shown in FIG. 15, the tank unit 500 includes a tank 550 capable of reserving a liquid L and the production apparatus 100 for a liquid containing gas bubbles, which is placed inside the tank 550.

The tank unit 500 has, for example, an attachment portion (not shown) for attaching the casing 10 to the tank 550 and is attached to an inner surface of a wall portion of the tank 550. In this embodiment, the production apparatus 100 for a liquid containing gas bubbles is configured such that the entire area including the inlet 11a and the outlet 11b of the casing 10 can be immersed in the liquid L of the tank 550. In this case, the feed pipe 13 having the gas injection unit 40 extends outside the tank 550 from the casing 10 and is connected to a gas source (not shown). Moreover, the motor 22 is typically disposed outside the tank 550. The present invention is not limited thereto, and the motor 22 may be configured to be capable of being immersed in the liquid L together with the casing 10.

An input operation unit (not shown) of the production apparatus 100 for a liquid containing gas bubbles may be provided in an outer surface of the wall portion of the tank 550. Accordingly, a user's input operation such as activation and deactivation of the production apparatus 100 for a liquid containing gas bubbles can be performed.

In the tank unit 500 according to this embodiment, the production apparatus 100 for a liquid containing gas bubbles takes in the liquid L of the tank 550, generates liquid containing minute gas bubbles with a high density, and discharges the liquid containing minute gas bubbles into the liquid L of the tank 550. In addition, passing of the liquid L through the production apparatus 100 for a liquid containing gas bubbles plural times increases the density of minute gas bubbles of the liquid in the tank 550.

As described above, the use of the tank unit 500 according to this embodiment makes it possible to produce and reserve a liquid containing gas bubbles in the tank 550. Therefore, a piping line for circulating the liquid containing gas bubbles becomes unnecessary. Accordingly, the system can be configured to be compact. Therefore, an equipment configuration using the liquid containing gas bubbles as a treatment solution can be simplified.

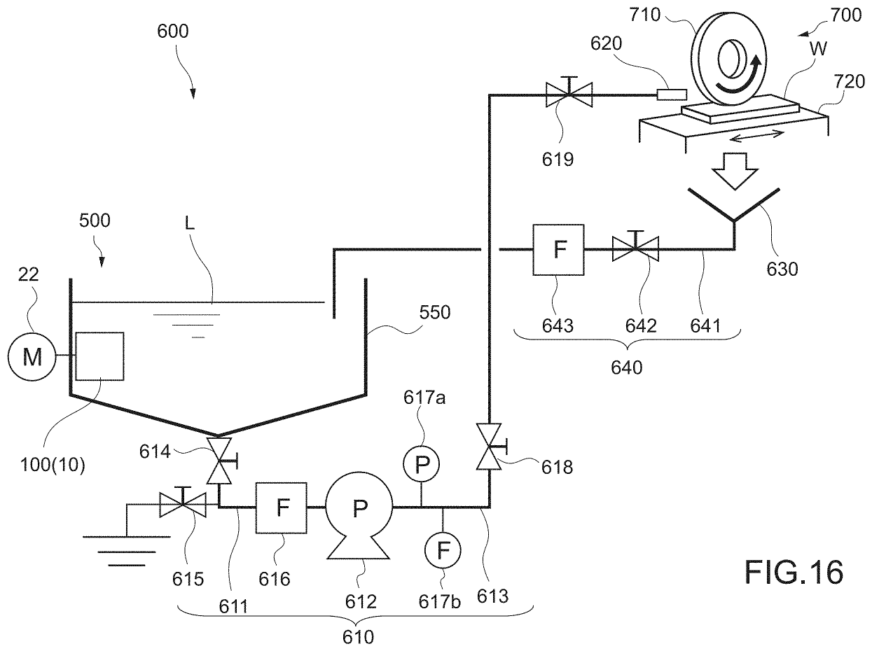

FIG. 16 is a schematic configuration diagram of a system 600 including the tank unit 500.

The system 600 shown in FIG. 16 is configured as a grinding lubricant supply system that supplies a grinding lubricant (coolant fluid) to be used for a grinding apparatus. The liquid containing gas bubbles according to this embodiment is a grinding lubricant containing minute gas bubbles such as UFB. Hereinafter, the liquid containing gas bubbles according to this embodiment will be also referred to as a grinding lubricant containing gas bubbles.

The minute gas bubbles such as UFB have a surface-active effect and a microbiostatic effect with respect to causative substances of contamination of the grinding lubricant, a suppression effect of the odor of the grinding lubricant, and the like. Moreover, the grinding lubricant containing gas bubbles enables prevention of clogging with a grinding powder during a grinding process, reduction of the replacement frequency of a tool such as a grindstone, quality improvement of a product to be worked, and the like.

The system 600 includes the tank unit 500 having the above-mentioned configuration, a liquid supplying line 610, a liquid supplying unit 620, a waste-liquid collecting unit 630, and a waste-liquid collecting line 640.

The tank unit 500 includes the tank 550 and a production apparatus 100 for a liquid containing gas bubbles. The tank 550 is capable of storing a liquid L (grinding lubricant containing gas bubbles). The production apparatus 100 for a liquid containing gas bubbles is placed inside the tank 550. The tank 550 is configured as a reservoir tank capable of reserving the grinding lubricant L containing gas bubbles. As described above, the casing 10 of the production apparatus 100 for a liquid containing gas bubbles is attached to the inner surface of the wall portion of the tank 550.

The liquid supplying line 610 has, for example, a first piping 611, a liquid feed pump 612, and a second piping 613.

The first piping 611 connects the tank unit 500 to the liquid feed pump 612. In the example of FIG. 16, the first piping 611 is connected to the bottom portion of the tank 550. A liquid supply valve 614, a liquid discharge valve 615, and a filter 616 are connected to the first piping 611. The filter 616 is used for removing impurities from the grinding lubricant L containing gas bubbles that is flowing through the first piping 611.

The liquid feed pump 612 is connected to the first piping 611 and the second piping 613. The liquid feed pump 612 feeds the grinding lubricant L containing gas bubbles, which is supplied from the tank unit 500 via the first piping 611, into the second piping 613.

For example, a pressure gauge 617a, a flowmeter 617b, and a pressure/flow rate adjustment valve 618, a liquid supplying valve 619 are connected to the second piping 613. The pressure/flow rate adjustment valve 618 adjusts the pressure and the flow rate of the grinding lubricant L containing a gas in the second piping 613 on the basis of measurement results of the pressure gauge 617a and the flowmeter 617b. The second piping 613 is connected to the liquid supplying unit 620 via the liquid supplying valve 619.

The liquid supplying unit 620 supplies the grinding lubricant containing gas bubbles into a grinding apparatus 700. The grinding apparatus 700 includes, for example, a tool 710 such as a grindstone for grinding a workpiece W and a support table 720 for supporting the workpiece W. The liquid supplying unit 620 supplies the liquid L containing gas bubbles into the area between the tool 710 and the workpiece W, for example.

The waste-liquid collecting unit 630 is a configuration for collecting the grinding lubricant L containing gas bubbles supplied into the grinding apparatus 700 as a waste liquid. The waste-liquid collecting unit 630 includes, for example, a container, a water drain port, and the like (not shown) that are disposed below the support table 720.

The waste-liquid collecting line 640 is connected to the waste-liquid collecting unit 630 and supplies the collected grinding lubricant L containing gas bubbles into the tank 550. The waste-liquid collecting line 640 includes a third piping 641, a pressure/flow rate adjustment valve 642, and a filter 643. The pressure/flow rate adjustment valve 642 and the filter 643 are connected to the third piping 641. The filter 643 is used for removing impurities from the grinding lubricant flowing the third piping 641 of the waste-liquid collecting line 640.

In the supply system 600 for a liquid containing gas bubbles having the above-mentioned configuration, the tank 550 is first filled with a stock solution that is a grinding lubricant. Then, the production apparatus 100 for a liquid containing gas bubbles is activated. Accordingly, the grinding-lubricant stock solution in the tank 550 is changed into the grinding lubricant L containing gas bubbles.

The grinding lubricant L containing gas bubbles, which is generated in the tank 550, is supplied into the grinding apparatus 700 from the liquid supplying unit 620 through the liquid supplying line 610. Accordingly, the workpiece W is subjected to grinding using the grinding lubricant L containing gas bubbles.

The used grinding lubricant L containing gas bubbles, which flows out of the support table 720, is supplied into the waste-liquid collecting line 640 via the waste-liquid collecting unit 630. Then, impurities such as grinding chips are removed through the filter 643 of the waste-liquid collecting line 640 and is supplied into the tank 550 again.

The production apparatus 100 for a liquid containing gas bubbles is capable of generating minute gas bubbles such as UFB with a high density. Accordingly, the grinding lubricant put in the tank 550 can be changed into the grinding lubricant L containing gas bubbles in a short time. Therefore, the time for preparing the grinding lubricant L containing gas bubbles can be shortened and the productivity of the grinding process can be improved.

Moreover, the high-density minute gas bubbles can sufficiently provide the washing effect, the clogging prevention effect, and the like. Therefore, the replacement frequency of the grinding lubricant, the tool, the pipings, and the like can be reduced, and the costs related to the grinding can be reduced.

In addition, since the production apparatus 100 for a liquid containing gas bubbles is placed inside the tank 550, the entire system can be downsized. Moreover, the production apparatus 100 for a liquid containing gas bubbles and the tank unit 500 can be easily introduced into an existing grinding lubricant supply system, and the introduction costs can be reduced.

Moreover, the production apparatus 100 for a liquid containing gas bubbles is compact and low-cost. Therefore, the supply system 600 for a liquid containing gas bubbles can be flexibly configured in accordance with desired density and the like of minute gas bubbles. For example, the tank unit 500 may have a configuration including a plurality of production apparatuses 100 for a liquid containing gas bubbles for the tank 550. Accordingly, a large amount of liquid containing high-density gas bubbles can be produced in a short time also in a case where the tank 550 is large, for example.

### Other Embodiments

For example, ultra-fine bubbles have a variety of effects such as an oxidization suppression effect and a gas supplying effect other than the above-mentioned washing effect. Therefore, the supply system for a liquid containing gas bubbles including the production apparatus for a liquid containing gas bubbles according to the present invention, the storage unit (tank), and the liquid supplying unit can also be used for the following applications.

For example, the supply system for a liquid containing gas bubbles according to the present invention can also be configured as a washing water supply system that washes food products, precision instruments, and the like by using, for example, purified water as the liquid and using, for example, the air or ozone as the gas.

Moreover, the supply system for a liquid containing gas bubbles according to the present invention can also be configured as an oxidization prevention water supply system that prevents oxidization of fish and meat and the like by using, for example, purified water as the liquid and using, for example, nitrogen as the gas.

Alternatively, the supply system for a liquid containing gas bubbles according to the present invention can also be configured as a supply system for a liquid containing gas bubbles for a bathtub by using, for example, water as the liquid and using, for example, carbon dioxide or the air as the gas. This supply system for a liquid containing gas bubbles may be incorporated in a hot-water supply system or may be connected to the hot-water supply system. Alternatively, using the bathtub main body as the “storage unit” and attaching the production apparatus for a liquid containing gas bubbles to a part of the bathtub, the bathtub may be configured as a reservation container for a liquid containing gas bubbles including the production apparatus for a liquid containing gas bubbles.

Moreover, the supply system for a liquid containing gas bubbles according to the present invention can be configured as a water supply system for culturing aquatic animals such as fishes by using, for example, water or sea water as the liquid and using, for example, oxygen as the gas. Accordingly, oxygen can be sufficiently mixed in the water used for the culture, and the growth of the aquatic animals can be promoted.

Moreover, the supply system for a liquid containing gas bubbles according to the present invention can be configured as a water sprinkle system for plants by using, for example, water or liquid fertilizer as the liquid and using, for example, carbon dioxide or nitrogen as the gas. Accordingly, the plants can be supplied with a liquid containing gas bubbles in which a desired gas is mixed, and the plant growth or the like can be promoted.

Hereinabove, the embodiments of the present invention have been described, though the present invention is not limited only to the above-mentioned embodiments and various modifications can be made as a matter of course.

For example, in the above-mentioned first embodiment, the description has been made exemplifying the production apparatus 100 for a liquid containing gas bubbles including the pump unit 30, though the pump unit 30 may be omitted. In this case, it is sufficient to additionally provide a hydraulic pump in the piping line for feeding a liquid into the inlet 11a.

Moreover, in the above-mentioned first embodiment, the pump unit 30 is configured as the centrifugal pump, though not limited thereto. Another pump structure such as a vane pump and a cascade pump (vortex pump) may be employed.

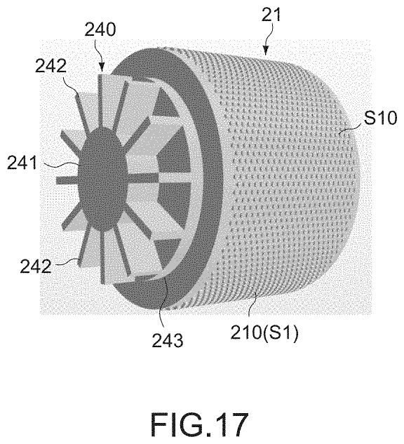

Moreover, in the above-mentioned second embodiment, the impeller 24 serving as the rotation applying unit is formed to have the same outer diameter as the rotor 21, though not limited thereto. For example, as shown in FIG. 17, an impeller 240 may have an outer diameter smaller than the outer diameter of the rotor 21. In this case, due to the reduced volume of the impeller 240, the number of revolutions of the impeller 240 can increase, which can also increase shearing force of the rotor 21 to a liquid.

It should be noted that the shapes of the blade portions 242 are not limited to the above-mentioned streamline shapes, and may be formed to extend linearly and radially as shown in FIG. 17.

In addition, in each of the above-mentioned embodiments, the cylindrical portion 212 that constitutes the rotor 21 is formed in the cylindrical shape, though not limited thereto. The tube portion of the rotor may have a truncated cone shape. In this case, the facing member that faces the tube portion via the predetermined clearance is also formed in a truncated cone shape. The tube portion and the facing member each having the truncated cone shape are placed in such a position that the diameters increase to the outlet side from the inlet side of the casing, for example.

1. A production apparatus for a liquid containing gas bubbles, comprising:
a casing including an inlet, into which a liquid with a gas injected therein flows, and an outlet; and
a shearing mechanism unit that is provided between the inlet and the outlet and applies shearing force to a liquid flowing to the outlet from the inlet, wherein
the shearing mechanism unit includes
a rotor that includes a rotary shaft and a tube portion and is rotatably disposed inside the casing, the tube portion having an outer peripheral portion including a first structure surface in which a plurality of dimples is formed circumferentially and axially,
a rotation applying unit that is provided in the rotary shaft and applies rotating force around the rotary shaft to the rotor, and
a tubular facing member that has an inner peripheral portion and is provided in an inner wall portion of the casing, the inner peripheral portion facing the first structure surface via a predetermined clearance.

2. The production apparatus for a liquid containing gas bubbles according to claim 1, wherein
the inner peripheral portion of the facing member has a second structure surface which faces the first structure surface and in which a plurality of dimples is formed circumferentially and axially.

3. (canceled)

4. The production apparatus for a liquid containing gas bubbles according to claim 1, wherein
the predetermined clearance is 1.0 mm or more and 3.0 mm or less.

5. The production apparatus for a liquid containing gas bubbles according to claim 1, wherein
the outlet is connected to a delivery pipe that extends horizontally.

6. A production system for a liquid containing gas bubbles, comprising:
a tank that reserves a liquid; and
a production apparatus for a liquid containing gas bubbles, which is placed inside the tank and includes
a casing including an inlet and an outlet,
a shearing mechanism unit that is provided between the inlet and the outlet and applies shearing force to a liquid flowing to the shearing mechanism unit from the inlet,
a gas injection unit that is connected to the inlet and injects a gas into a liquid introduced into the inlet, and
a pump unit that is attached to the shearing mechanism unit and transports a liquid to the outlet from the inlet by driving of a motor,
wherein
the shearing mechanism unit includes
a rotor that includes a rotary shaft and a tube portion and is rotatably disposed inside the casing, the tube portion having an outer peripheral portion including a first structure surface in which a plurality of dimples is formed circumferentially and axially,
a motor that is provided in the rotary shaft and applies rotating force around the rotary shaft to the rotor and the pump unit, and
a tubular facing member that has an inner peripheral portion and is provided in an inner wall portion of the casing, the inner peripheral portion facing the first structure surface via a predetermined clearance.

7. The production apparatus for a liquid containing gas bubbles according to claim 1, wherein
the rotation applying unit is a motor disposed outside the casing.

8. The production apparatus for a liquid containing gas bubbles according to claim 1, wherein the rotation applying unit is an impeller that is disposed inside the casing and rotates by receiving a pressure of liquid introduced into the inlet.

9. The production apparatus for a liquid containing gas bubbles according to claim 7, further comprising
a pump unit that is attached to the rotary shaft and transports a liquid into the shearing mechanism unit from the inlet by driving of the motor.

10. The production apparatus for a liquid containing gas bubbles according to claim 9, wherein
the pump unit has
a circular base that is fixed to an end portion of the tube portion which is located on a side of the inlet and
a plurality of blade portions that is provided in the base and radially extends to a circumferential portion from a center portion of the base.

11. The production apparatus for a liquid containing gas bubbles according to claim 10, wherein
the pump unit further includes a plurality of protrusion portions that is provided in the base and positioned between the plurality of blade portions
